(19) United States
(12) Patent Application Publication
(10) Pub. No.: US 2008/0022050 A1
(43) Pub. Date: Jan. 24, 2008

(54) Pre-Fetching Data for a Predictably Requesting Device

(75) Inventor: Hon Chung Fung, Flower Mound, TX (US)

Correspondence Address: THOMAS, KAYDEN, HORSTEMEYER & RISLEY, LLP, 600 GALLERIA PARKWAY, STE 1500, ATLANTA, GA, 30339, US

(73) Assignee: VIA TECHNOLOGIES, INC., Hsin-Tien (TW)

(21) Appl. No.: 11/534,794

(22) Filed: Sep. 25, 2006

Related U.S. Application Data
(60) Provisional application No. 60/807,649, filed on Jul. 18, 2006.

(51) Int. Cl. G06F 12/00

(52) U.S. Cl. 711/137

(57) ABSTRACT

Systems and methods are disclosed herein for controlling the way in which data access requests from different masters are handled. In one example, a memory controller comprises a request analyzer configured to receive a data access request via a data bus. The request analyzer is further configured to analyze the request to determine the identity of a master making the request. The memory controller also includes a buffer system configured to store data and a controller device configured to control how data is stored in the buffer system. The controller device controls data storage within the buffer system based on the identity of the master making the request. Generally, the memory controller may operate by transmitting a first data block in response to a request thereto and pre-fetching a second data block in anticipation of the second data block being requested on a next data access request.

### CROSS REFERENCE TO RELATED APPLICATION

This application claims the benefit of U.S. provisional application Ser. No. 60/807,649, filed Jul. 18, 2006, the contents of which are incorporated by reference herein.

### TECHNICAL FIELD

The present disclosure generally relates to computer systems having masters and slaves sharing a data bus. More particularly, the disclosure relates to systems and methods for pre-fetching data in anticipation of the data being requested by a master having a predictable request pattern.

### BACKGROUND

FIG. 1 is a block diagram of an example of a portion of a conventional integrated circuit (IC) chip 10. The chip 10 includes a number x of masters 12 and a number y of slaves 14, interconnected by a data bus 16. The chip 10 also includes a bus arbiter 18, which receives bus arbitration requests from the masters 12 and allows one master 12 at a time to control the bus 16. When a master 12 is given control of the bus 16, this controlling master 12 may then access any slave 14 as needed.

In the case where one of the slaves 14 is a memory controller, for example, a controlling master 12 may request access to data from a memory device controlled by the memory controller slave 14. The memory controller slave 14 receives the data access request and checks to see if the requested data is within an internal buffer, or cache, within the memory controller slave 14. If so, the data can be put out onto the bus 16 for the controlling master 12. However, requested data is often not in the buffer of the memory controller and it must therefore be retrieved from memory, as explained below with respect to FIG. 2.

FIG. 2 is a timing diagram illustrating an example of signal and data transfers when a master 12 requests data from a memory controller slave 14 according to the operation of the conventional IC chip 10 of FIG. 1. First, a controlling master 12 sends a data access request 20 to the memory controller slave 14 at the beginning of a request cycle. Most of the time, the requested data will not be readily available in cache. However, instead of telling the master 12 to wait, which would hold up the data bus 16 until the data is ready, the slave 14 sends a “split” signal 22 out onto the bus 16. This essentially tells the master 12 that the data is not available in the cache and to come back later.

After sending the split signal, the memory controller slave 14 proceeds to read data (“data 0”) from memory while the bus is released for other master requests. After the memory controller slave 14 retrieves this data, it then transmits an “un-split” signal 24 directly to the bus arbiter 18 indicating that the data is now available for immediate access. On the next request cycle, the controlling master 12 sends out a second request for the same data. Since the data would then be available, having been retrieved in response to the first request, the slave 14 puts the data (data 0) out onto the bus 16 for the master 12. This process is repeated for other data requests.

As is apparent from this conventional data retrieving system, it would typically require at least two request cycles to retrieve one block of data. A need exists in the industry to minimize the number of data access requests and the number of split/un-split signal transmissions to thereby more efficiently utilize the bandwidth of the bus 16. By minimizing the amount of time that the system unnecessarily waits for data to be retrieved from memory, it may be possible to provide greater bus availability for all the masters, thereby allowing the chip to operate at a faster speed.

### SUMMARY

The present disclosure is directed to systems and methods for controlling data access requests. In the case where a device requests data according to a predictable pattern, the data can be pre-fetched and stored in a special storage buffer in anticipation of the data being requested by the predictably requesting master. When the predictably requesting device requests this pre-fetched data, it can be immediately access this data from the special memory location.

In one embodiment of the present disclosure, a system comprises a memory device, a predictably requesting device, and a memory controller. The predictably requesting device is configured to issue requests to access data from the memory device, wherein the predictably requesting device has a tendency to issue requests in a predictable manner. The memory controller is configured to receive a data access request from the predictably requesting device and is further configured to access the requested data from the memory device in response to the data access request. The memory controller is operable to pre-fetch consequent data from the memory device in anticipation of the predictably requesting device requesting access to the consequent data.

In another embodiment, the present disclosure describes a memory controller comprising a request analyzer configured to receive a data access request via a data bus. The request analyzer is further configured to analyze the request to determine the identity of a device making the request. The memory controller also comprises a buffer system configured to store data and a controller device configured to control how data is stored in the buffer system based on the identity of the master making the request.

In addition, the present disclosure describes a method for controlling data access requests. The method in this embodiment comprises transmitting a first data block in response to a request to access the first data block. The method also comprises pre-fetching a second data block in anticipation of the second data block being requested on a next data access request. The transmitting and pre-fetching may be handled substantially simultaneously.

Other systems, methods, features, and advantages of the present disclosure will be apparent to one having skill in the art upon examination of the following drawings and detailed description. It is intended that all such additional systems, methods, features, and advantages be included within this description and protected by the accompanying claims.

### BRIEF DESCRIPTION OF THE DRAWINGS

Many aspects of the embodiments disclosed herein can be better understood with reference to the following drawings. Like reference numerals designate corresponding parts throughout the several views.

FIG. 1 is a block diagram illustrating a conventional master/slave configuration of an integrated circuit chip.

FIG. 2 is a timing diagram of exemplary signals of the conventional integrated circuit chip of FIG. 1.

FIG. 3 is a block diagram of an embodiment of a portion of a computer system according to the teachings of the present application.

FIG. 4 is a block diagram of an embodiment of the memory controller shown in FIG. 3.

FIG. 5 is a block diagram of an embodiment of the request analyzer shown in FIG. 4.

FIG. 6 is a block diagram of an embodiment of the controller device shown in FIG. 4.

FIG. 7 is a block diagram of a first embodiment of the buffer system shown in FIG. 4.

FIG. 8 is a block diagram of a second embodiment of the buffer system shown in FIG. 4.

FIG. 9 is a timing diagram illustrating exemplary signals associated with the memory controller of FIG. 4.

FIG. 10 is a flow chart illustrating an embodiment of a method for managing data access requests.

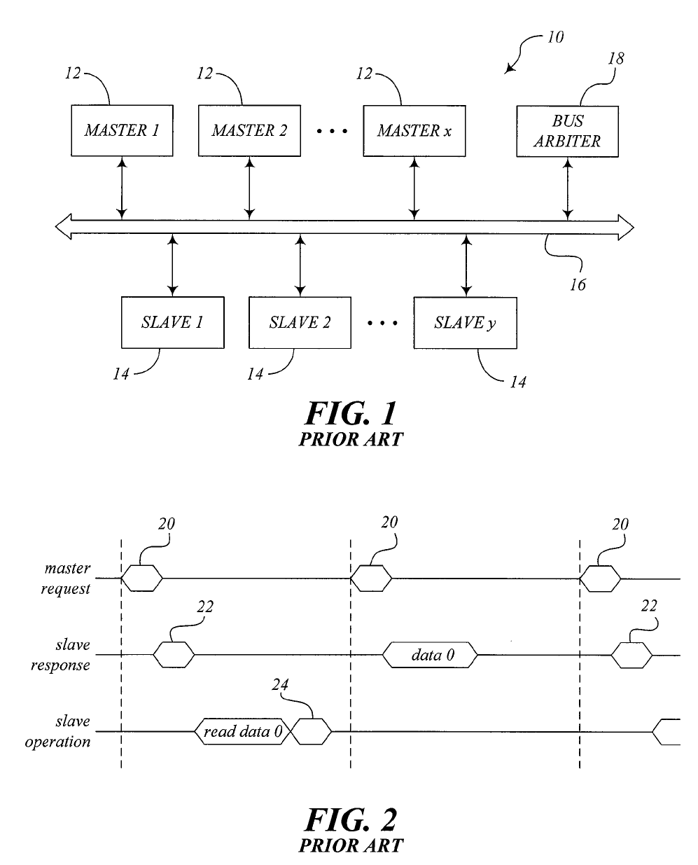

### DETAILED DESCRIPTION

The present application describes systems and methods for pre-fetching data for a master that requests data according to a predetermined or predictable sequence. For example, the systems and methods described herein may be configured within a computer system, particularly an integrated circuit (IC) chip or processor having a commonly shared bus. By pre-fetching data that is likely to be requested on a next request cycle, the number of split and un-split signals can be reduced and the shared components of the system will not be unnecessarily occupied. In this regard, the teachings herein may reduce the processing time and allow a processor to operate more efficiently.

In a computer processing system, the data bus, memory controller, and external memory are common resources, shared by the processor and a number of masters and peripheral devices. It is therefore beneficial to optimize the utilization of these common resources by every bus user. In some cases, certain masters request data at predictable addresses in memory or read data from sequential memory locations. A video display controller, for example, such as an LCD controller, drives a video display, such as an LCD display, in a predictable fashion. The LCD display controller sends pixels one by one to the LCD display in a continuous scanning operation, working from top to bottom. Since the LCD display controller reads pixels in the frame buffer sequentially, the present application takes advantage of this predictable requesting pattern to provide more efficient operation.

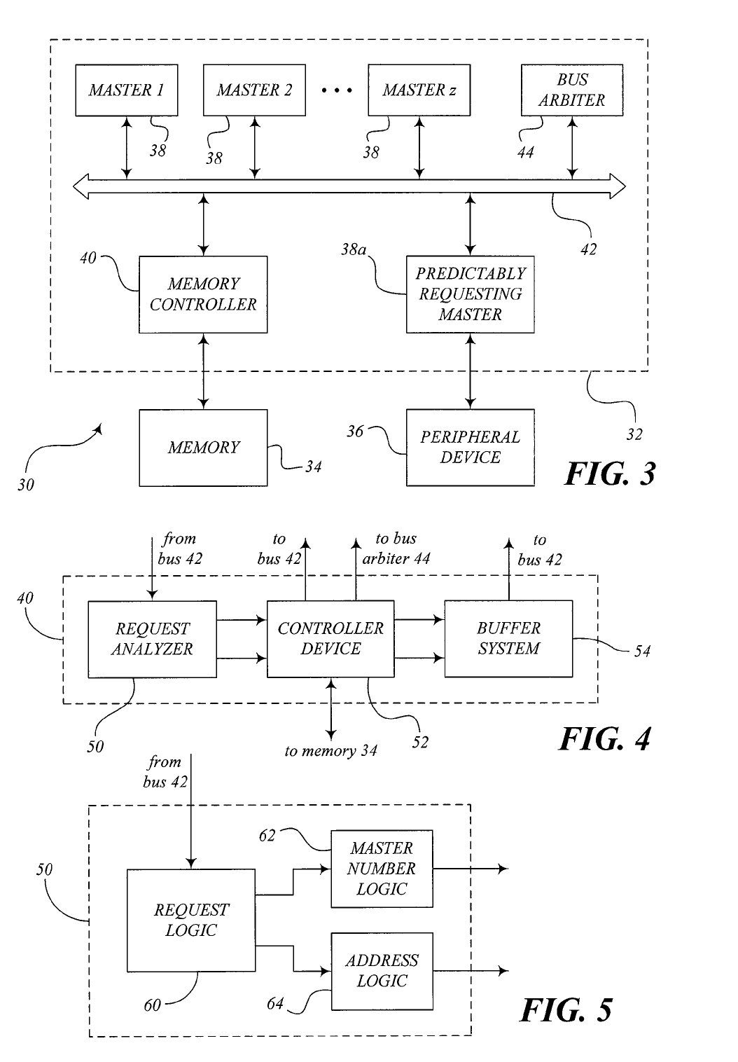

FIG. 3 is a block diagram of an embodiment of a portion of a computer system 30 according to the teachings of the present application. The computer system 30 includes, among other things, an integrated circuit (IC) chip 32, memory 34, and at least one peripheral device 36. The memory 34 may include read-only memory (ROM) and/or random access memory (RAM) and preferably includes dynamic random access memory (DRAM). The memory 34 is external to the chip 32 and is accessed differently from any cache memory within the chip 32. The peripheral device 36, for example, may be a display device, such as a raster scan display, CRT display, LCD display, or other suitable display device.

The chip 32 includes, among other things, a plurality of masters 38, of which at least one master 38 is a predictably requesting master 38a. The predictably requesting master 38a is a device normally operating in such a way where it requests data from memory 34 according to a highly predictable pattern. Although only one predictably requesting master 38a is illustrated in FIG. 3, it should be noted that the chip 32 may include any number of predictably requesting masters 38a.

The chip 32 also includes at least one slave, illustrated in FIG. 3 as a memory controller 40. Although only one slave is illustrated in this embodiment, it should be noted that the chip 32 may include any number of slaves. The masters 38 and memory controller 40 are interconnected via a data bus 42. The chip 32 also includes a bus arbiter 44, which receives bus requests from the masters 38 and allows one master 38 at a time to control the bus 42. When a master 38 is given control of the bus 42, the controlling master 38 may then access any slave, such as the memory controller 40, as needed.

In the embodiment of FIG. 3, the peripheral device 36 is preferably a video display and the predictably requesting master 38a is preferably a video display controller that controls the video display. Typically, the video display controller retrieves video data from memory in a highly predictable manner and provides the video data to the video display in a constant stream. Normally, video data is stored in a block of memory known as a frame buffer, which can be allocated or stored at a certain part of the memory 34. Each pixel in the video frame is retrieved in a scanning pattern sequence that is usually consistent with the sequence in which the pixel data is stored in the addresses in memory 34.

FIG. 4 is a block diagram of an embodiment of the memory controller 40 shown in FIG. 3. The memory controller 40 in this embodiment includes a request analyzer 50, a controller device 52, and a buffer system 54. In general, the memory controller 40 operates as follows. The request analyzer 50 receives a request from one of the masters 38 via the bus 42 to access data from memory 34. In response to the data access request, the request analyzer 50 processes the request signal to determine the identity of the master 38 making the request and to determine the address of the requested data in memory 34. The master's identity can be determined based on the master number of the request. The request analyzer 50 sends the information concerning the requesting master's identity and the requested data address to the controller device 52. The controller device 52 determines whether the requested data is already in the buffer system 54. If not, then the controller device 52 sends a “split” signal to the bus 42.

Then, according to the teachings of the present application, the controller device 52 retrieves the requested data from memory 34 and places the data within the buffer system 54 based on the identity of the master 38. The controller device 52 sends a signal to the buffer system 54 controlling where the data is stored in the buffer system 54. If the requesting master 38 is the predictably requesting master 38a, then the data is stored in a special section of the buffer system 54. Otherwise, the data is stored in general buffer space in the buffer system 54. After successfully storing the requested data in the buffer system 54, the controller device 52 may optionally send an “un-split” signal to the bus arbiter 44 signaling that the requested data is now available. When the master 38 requests the data a second time, the data will usually be available in the buffer system 54. If it is available, the controller device 52 instructs the buffer system 54 to put the requested data out onto the bus 42.

In addition, the memory controller 40 is capable of pre-fetching data that the predictably requesting master 38a is likely to request next and placing this pre-fetched data in the special location in the buffer system 54. In this regard, if the pre-fetched data is requested in the next request, then the controller device 52 instructs the buffer system 54 to immediately put the requested data out onto the bus 42. In this regard, it is not necessary to send a split signal since the data is already available. The controller device 52 is capable of predicting this next data request by the predictably requesting master 38a. When the prediction is correct, it is not necessary to transmit the split signal, un-split signal, and the second data access request since the data can be accessed without additional waiting time. Furthermore, if the data inside the special cache buffer drops below a certain threshold, the controller device 52 may start the pre-fetching operation without actually receiving a read request from the predictably requesting master 38a. This will assure that the special buffer is sufficiently filled for future requests.

When a predictably requesting master 38a, such as a video display controller, makes a request for a first block of sequentially stored data, such as video frame data, the memory controller 40 can analyze this request to anticipate sequential requests and begin the “pre-fetch” operation from this initial request. When the request analyzer 50 determines that the identity of the requesting master is the predictably requesting master 38a, the memory controller 40 pre-fetches the next anticipated portions of data. If the next request address matches the anticipated address, then the memory controller 40 can immediately respond with data inside the buffer system 54. Since the frame buffer read is sequential, the hit rate within the buffer system 54 (the rate when the buffer system 54 contains valid data) is very high. The only time the video display controller misses is when it jumps to a different address, e.g. when it reaches the end of the frame buffer and restarts at the beginning of another frame located in a separate memory location. The details of embodiments and operations of the request analyzer 50, controller device 52, and buffer system 54 of the memory controller 40 are described below with reference to FIGS. 5-8.

FIG. 5 is a block diagram of an embodiment of the request analyzer 50 shown in FIG. 4. The request analyzer 50 of this embodiment includes request logic 60, master number logic 62, and address logic 64. The request logic 60 receives the data access request via the bus 42 and breaks the request down into a master number portion and an address portion. The request logic 60 sends the master number portion to the master number logic 62 and sends the address portion to the address logic 64.

The master number logic 62 processes the master number portion of the request to determine the identity of the master 38 making the request. The master number logic 62 may also store a list of masters 38 that can be categorized as “predictably requesting masters”, such as, for example, video display controllers, DMA controllers, etc. From this list of predictably requesting masters, the master number logic 62 provides an identity signal to the controller device 52 and buffer system 54. The identity signal indicates whether or not the master is a predictably requesting master and can also identify the master from a plurality of predictably requesting masters. When a predictably requesting master is identified, the identity signal also indicates that a particular dedicated buffer in the buffer system 54, as defined below, should be utilized for storing data, both regularly retrieved data and pre-fetched data, for that predictably requesting master 38a. If the identified master is not on the predictably requesting masters list, then the master number logic 62 instructs the buffer system 54 to store data in a general buffer, as defined below, of the buffer system 54.

The address logic 64 processes the address portion of the request from the request logic 60 to determine if the address of the requested data corresponds to an address of data already stored in the buffer system 54. The address logic 64 may keep an updated list of addresses currently in the buffer system 54 or, alternatively, may compare the requested address with the buffered data addresses by directly accessing this information from the buffer system 54.

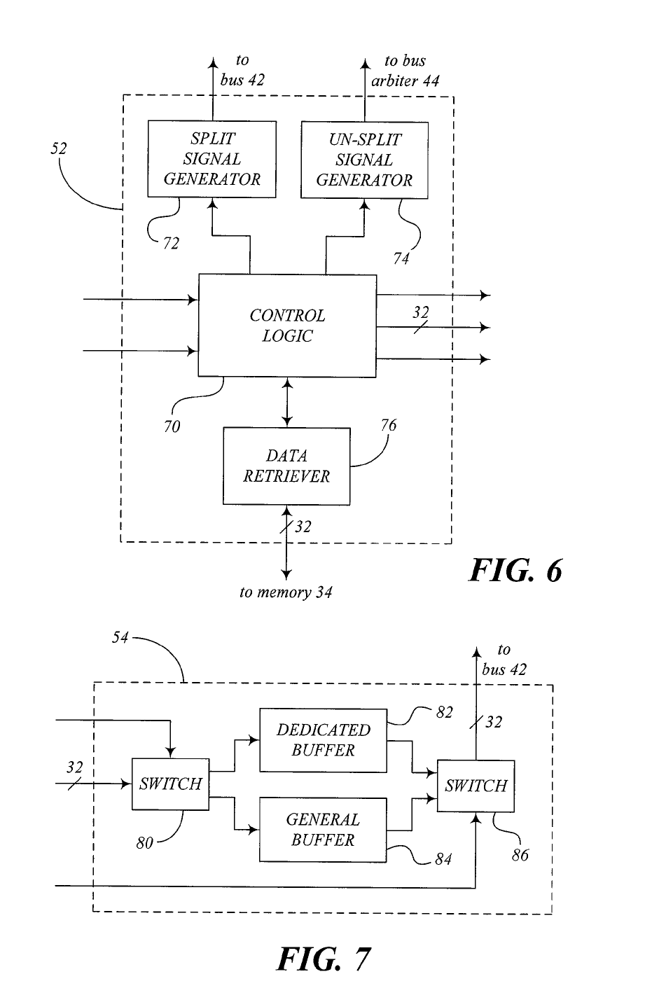

FIG. 6 is a block diagram of an embodiment of the controller device 52 shown in FIG. 4. The controller device 52, according to this embodiment, includes control logic 70, a split signal generator 72, an optional un-split signal generator 74, and a data retriever 76. The un-split signal generator 74 may be omitted from the circuit if it is not necessary for the operation of the memory controller 40. The control logic 70 receives the information concerning the master number from the master number logic 62 and the requested address from the address logic 64 of the request analyzer 50. When the address information indicates that the requested data is not in the buffer system 54, the control logic 70 instructs the split signal generator 72 to generate a split signal and put this signal out onto the bus 42. Also, at this time, the control logic 70 instructs the data retriever 76 to retrieve the requested data from memory 34. When the data retriever 76 retrieves the data from memory 34, the control logic 70 transfers this data to a predetermined location in the buffer system 54. If the master number logic 62 indicates to the control logic 70 that the master is a predictably requesting master 38a, the control logic 70 instructs the buffer system 54 (using a first instruction signal) to store the data in a special buffer dedicated to that predictably requesting master 38a. If the master is not a predictably requesting master, then the control logic 70 instructs the buffer system 54 (using the first instruction signal) to store the data in a general buffer. Once the requested data is stored in the buffer system 54, the control logic 70 instructs the un-split signal generator 74, if present, to generate an un-split signal and send this signal to the bus arbiter 44. The control logic 70 also sends a second instruction signal to indicate whether the data is stored in the special buffer or general buffer.

When the requesting master is a predictably requesting master 38a, the control logic 70 instructs the data retriever 76 to pre-fetch data for the special buffer in the buffer system 54. When the address of subsequent requests matches an address of data in the buffer system 54, e.g. as a result of pre-fetching, the control logic 70 instructs the buffer system 54 to put the requested data out on the bus 42. In this embodiment, the size of the data block retrieved from memory 34 and transferred to the buffer system 54 is illustrated as being 32 bytes. Although this block size may be preferred in this embodiment, it should be noted that alternative embodiments may utilize any suitable size as desired.

FIG. 7 is a block diagram of a first embodiment of the buffer system 54 shown in FIG. 4. In this embodiment, the buffer system 54 includes a first switch 80, a dedicated buffer 82, a general buffer 84, and a second switch 86. The buffers 82 and 84 may be cache memory having a first-in, first-out (FIFO) configuration and are not necessarily large. For example, the size of the dedicated buffer 82 may depend on the size of a video display device or other peripheral device controlled by a predictably requesting master 38a. The size may also depend on the data range going out to the peripheral device, how fast data is needed, etc. Since pre-fetched data is stored in the dedicated buffer 82, the size of the dedicated buffer 82 should be large enough to avoid complete depletion. As an example, the dedicated buffer 82 may be configured to store 32 or 64 entries, where each entry is 32 bits.

The first and second switches 80 and 86 may be configured using any suitable type or combination of electronic or logic components capable of providing the switching functions described below. Alternatively, the switches 80 and 86 may be replaced by any suitable switching configuration capable of providing the below-described switching functions. The first switch 80 may operate in a manner consistent with the operation of a demultiplexer and the second switch 86 may operate in a manner consistent with the operation of a multiplexer. A first instruction signal from the control logic 70 of the controller device 52 may be used to control the first switch 80 to select in which one of the buffers 82 or 84 the retrieved data is to be stored. If the first instruction signal indicates that the requesting master is a predictably requesting master 38a, then the data is stored in the dedicated buffer 82. If the first instruction signal indicates that the requesting master is not a predictably requesting master, then the data is stored in the general buffer 84. The second switch 86 receives a second instruction signal from the control logic 70 when data is to be put out onto the bus 42. Also, this instruction signal indicates from which buffer the data is to be taken. When a predictably requesting master 38a requests data that is stored in the dedicated buffer 82, the second switch 86 allows the data stored therein to be put out onto the bus 42. However, if any other master 38 is making the request and the requested data is already stored in the buffer system 54, then the switch 86 allows the data from the general buffer 84 to be put out onto the bus 42.

The dedicated buffer 82 is dedicated for use primarily by one master that requests data according to a predictable pattern. The controller device 52 can predict which data might be requested next by this master and then “pre-fetch” this data before the actual request. Based on a previous request, the prediction of a next block of data in memory can be made. In this way, the data can be stored ahead of the request. Therefore, when a request is received for that data, the memory controller 40 can immediately respond with the desired data. In this regard, two requests for the data would not be required and the generation of the split and un-split signals would not be needed since the pre-fetched data can be provided immediately upon request.

The general buffer 84 is used by the masters other than the one dedicated master. The general buffer 84 stores data according to typical operations and may require two requests for the data and the splitting and unsplitting of signals. This buffer is in parallel with the dedicated buffer 82 and can store a nominal amount of data handled by a typical memory controller. By placing the buffers in parallel, if another master gains control of the bus while the anticipated pre-fetched data is stored in the dedicated buffer 82, the pre-fetched data can still be retrieved when the predictably requesting master again gains control of the bus, without missing the pre-fetched data.

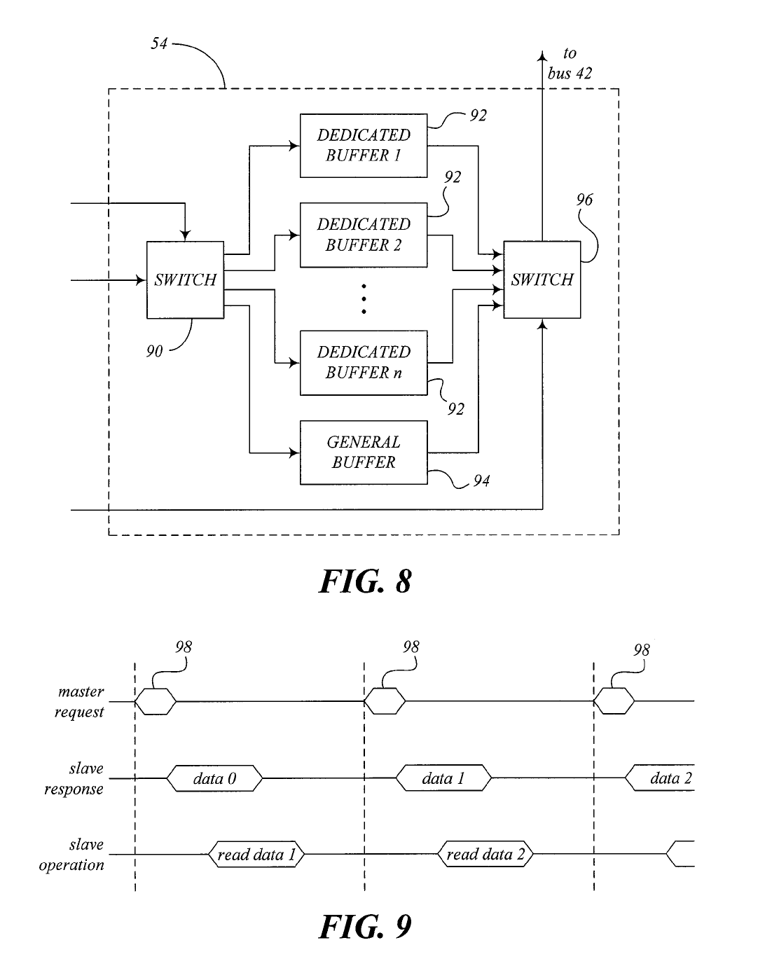

FIG. 8 is a block diagram of a second embodiment of the buffer system 54 shown in FIG. 4. In this embodiment, the buffer system 54 includes a first switch 90, a number n of dedicated buffers 92, a general buffer 94, and a second switch 96. The first and second switches 90 and 96 may be configured using any suitable type or combination of electronic or logic components capable of providing the switching functions described below. Alternatively, the switches 90 and 96 may be replaced by any suitable switching configuration capable of the below-described switching functions. The first switch 90 may operate in a manner consistent with a demultiplexer and the second switch 96 may operate in a manner consistent with a multiplexer.

An instruction signal from the control logic 70 of the controller device 52 may control the first switch 90 for selecting in which one of the multiple dedicated buffers 92 or general buffer 94 the retrieved data is to be stored. If the selection signal indicates that the requesting master is one of a number of predictably requesting masters, then the data is stored in a particular one of the n dedicated buffers 92. Pre-selected correlation information may be stored in the controller device 52 for correlating a certain one of multiple predictably requesting masters with a certain dedicated buffer 92. If the selection signal indicates that the requesting master is not a predictably requesting master 38a, then the data is stored in the general buffer 94. The second switch 96 receives an instruction signal from the control logic 70 of the controller device 52 when data is to be put out onto the bus 42. Also, this instruction signal indicates from which buffer the data is to be taken. When a predictably requesting master 38a requests data that is stored in its corresponding dedicated buffer 92, then the second switch 96 allows the data therein to immediately be put out onto the bus 42 without the need for a second request. If a master other than one of the predictably requesting masters is making the request and the requested data is already stored in the buffer system 54, then the second switch 96 allows the data from the general buffer 94 to be put out onto the bus 42.

It should be noted that the dedicated buffers 92 may be configured as one cumulative buffer having addresses specifically allocated to one or more masters. Alternatively, the dedicated buffers 92 and general buffer 94 also may be configured as a single cumulative buffer having portions allocated in any desirable manner. In these alternative embodiments, certain percentages of the cumulative buffer may be allocated for specific masters, depending on data size requirement or other parameters. Any portions of the buffer not specifically allocated to a particular master can be available as general storage for the remaining masters. Also, in this regard, instead of switches, the buffer system 54 may be configured such that portions of the cumulative buffer may be accessed using any suitable alternative accessing means.

The memory controller 40 of the present disclosure can be implemented in hardware, software, firmware, or a combination thereof. In the disclosed embodiments, any of the request logic 60, master number logic 62, address logic 64, and control logic 70 may be implemented, at least in part, in software or firmware that is stored in memory and that is executed by a suitable instruction execution system. Alternatively, this logic can be implemented in hardware with any combination of suitable components, such as discrete logical circuitry having gates for implementing logic functions, an application specific integrated circuit (ASIC), etc.

The embodiment of FIG. 8 may be utilized when the computer system 30 includes more than one master that requests data in a predictable manner. For instance, the computer system 30 may comprise a video display controller (a first predictably requesting master), a DMA controller (a second predictably requesting master), etc. An example of a method of operation of the computer system 30 of FIG. 3 utilizing the embodiment of the memory controller 40 of FIG. 4 or other suitable alternative embodiment within the scope of the present application will now be explained.

FIG. 9 is a timing diagram of exemplary signals transmitted throughout the computer system 30 applying the teachings of the present application. At a master's request for data, the slave can respond immediately with the requested data when anticipated data is pre-fetched. Even during the time that the data is being placed out on the bus, the slave may be in the process of pre-fetching the next anticipated data from memory. In this example, the data labeled “data 1” is pre-fetched in a preceding request cycle and stored in a dedicated buffer 82 or 92. If that data is requested in the next request, the data can be immediately read out to the bus while the next anticipated data block is read from memory. This process can continue until the dedicated master jumps to an address that was not anticipated. This may happen, for instance, when a raster scan device reaches the pixel in the lower right corner of the frame and jumps to a new block of memory storing the next frame beginning with the pixel in the upper left corner of the frame. Although this new block may not be easily predicted, the address logic 64 may alternatively include an additional prediction algorithm used in conjunction with the controller device 52 for attempting to anticipate a new block of data corresponding to the next frame. This anticipated data is stored in the dedicated buffer and may be evicted, if desired, when the following requests do not hit in the buffer system 54.

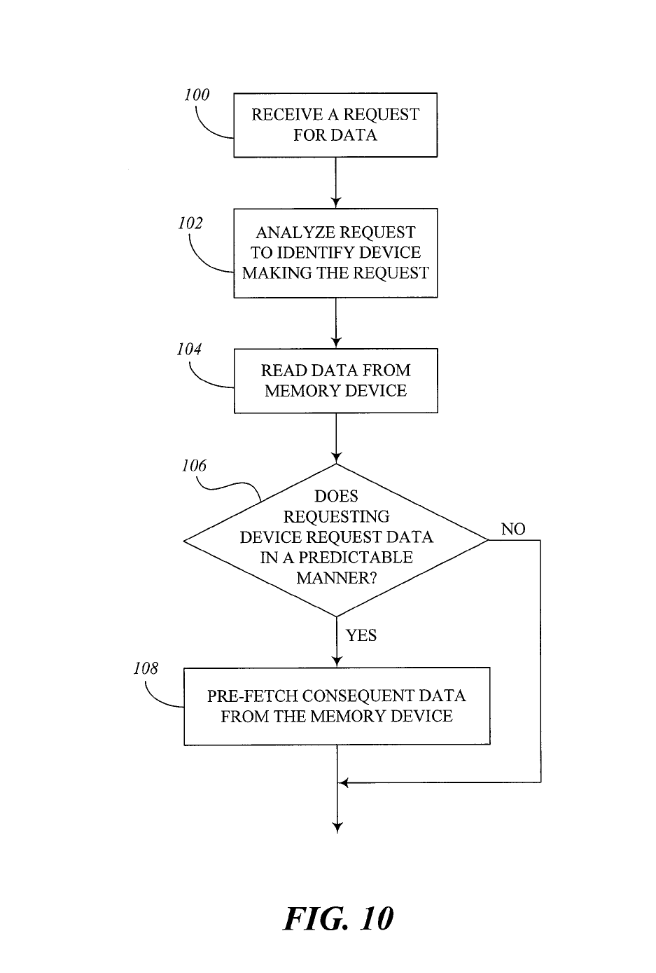

FIG. 10 is a flow diagram of an exemplary method for processing requests for data. The flow diagram begins by receiving a request for data, as indicated in block 100. The request can be made by any device, such as a master connected to a bus interface. In block 102, the request is analyzed to identify the device making the request. As an example, the master number can be extracted from the request to determine the master's identity. In block 104, the requested data is read from a memory device.

In decision block 106, it is determined whether or not the requesting device requests data in a predictable manner. If not, then no pre-fetching is performed for this device. If, however, it is determined in block 106 that the requesting device does request data in a predictable fashion, then the flow diagram proceeds to block 108. In block 108, consequent data is pre-fetched from the memory device. By pre-fetching data for a device that requests in a predictable manner, data that is likely to be requested can be read ahead of time in anticipation that this data will be needed imminently.

The method of operation of the memory controller 40, such as the method of FIG. 10, may include any suitable architecture, functionality, and/or operation of various implementations of processing software. In this regard, each function may be a module, segment, or portion of code, which comprises one or more executable instructions for implementing the specified logical functions. It should also be noted that in some alternative implementations, the functions may occur out of the specified order or executed substantially concurrently.

It should be emphasized that the above-described embodiments are merely examples of possible implementations. Many variations and modifications may be made to the above-described embodiments without departing from the concepts, principles, and teachings of the present disclosure. All such modifications and variations are intended to be included herein within the scope of this disclosure and protected by the following claims.

I claim:

1. A system comprising:
a requesting device configured to issue a data access request to access data from a memory device; and
a memory controller configured to pre-fetch data from the memory device in anticipation of receiving the data access request from the requesting device.

2. The system of claim 1, wherein the requesting device issues data access requests in a predictable manner.

3. The system of claim 2, wherein the memory controller is further configured to identify the requesting device issuing the data access request.

4. The system of claim 1, wherein memory controller is further configured to store the pre-fetched data from the memory device in a dedicated space.

5. The system of claim 1, wherein the memory controller further comprises:
a request analyzer configured to analyze the data access request from the requesting device;
a buffer system configured to store data; and
a controller device configured to control the location of data stored in the buffer system.

6. The system of claim 5, wherein the controller device stores data pre-fetched from the memory device in a dedicate space of the buffer system in response to the data access request.

7. A memory controller comprising:
a request analyzer configured to receive a data access request, and to analyze the data access request to determine the identity of a device making the data access request; and
a controller device configured to retrieve data from a memory device in response to the data access request and to pre-fetch consequent data from the memory device.

8. The memory controller of claim 7, wherein the request analyzer is further configured to determine whether the device has a tendency to make request in a predictable manner.

9. The memory controller of claim 8, wherein the controller device is further configured to pre-fetch consequent data in response to the data access request determined to be made by the device having the tendency.

10. The memory controller of claim 7, further comprising a buffer system for storing data.

11. The memory controller of claim 9, wherein the buffer system comprises a dedicated buffer in response to the data access request determined to be made by the device having the tendency.

12. The memory controller of claim 8, wherein the request analyzer comprises:
request logic configured to extract identity information and address information from the data access request;
identification logic configured to determine the identification of the device making the data access request; and
address logic configured to determine whether the requested data resides in the buffer system based on the address information.

13. The memory controller of claim 12, wherein the address logic determines whether the requested data is pre-fetched in the buffer system, and the identification logic determines whether the data access request is made by the device having the tendency.

14. The memory controller of claim 7, wherein the controller device comprises:
control logic configured to control data storage of the buffer system; and
a data retriever configured to retrieve data from the memory device.

15. The memory controller of claim 14, wherein the data retriever is further configured to pre-fetch data from the memory device in prior to the requesting device requests the pre-fetched data.

16. A method for controlling data access requests, the method comprising:
transmitting a first data block in response to a first data access request for the first data block; and
pre-fetching a second data block in anticipation of the second data block being requested on a second data access request received after the first data access request.

17. The method of claim 16, wherein transmitting the first data block and pre-fetching the second data block at least partially overlap in time.

18. The method of claim 16, further comprising transmitting the second data block at the first time of the second data block is requested.

19. The method of claim 18, wherein the first data block and second data block are transmitted in consecutive request cycles.

20. The method of claim 16, wherein transmitting the first data block further comprises receiving the first data access request, analyzing the first data access request to identify the device issuing the first data access request, and reading the first and the second data block from a memory device.
